(19) United States
(12) Patent Application Publication
(10) Pub. No.: US 2007/0116179 A1
(43) Pub. Date: May 24, 2007

(54) Flat image detector

(76) Inventors: Martin Spahn, Chicago, IL (US); Georg Wittmann, Herzogenaurach (DE)

Correspondence Address: HARNESS, DICKEY & PIERCE, P.L.C., P.O.BOX 8910, RESTON, VA, 20195, US

(21) Appl. No.: 11/603,082

(22) Filed: Nov. 22, 2006

(30) Foreign Application Priority Data
Nov. 24, 2005 (DE) 10 2005 056 048.2

(51) Int. Cl. H05G 1/64

(52) U.S. Cl. 378/98.8

(57) ABSTRACT

In order to configure a flat image detector such that it can be produced with as low an outlay as possible, a flat image detector of an example embodiment, including an active matrix of a plurality of pixel readout units, is provided. In the detector, at least a part of the active matrix is formed from at least one of an organic conducting or semiconducting material.

The present application hereby claims priority under 35 U.S.C. §119 on German patent application number DE 10 2005 056 048.2 filed Nov. 24, 2005, the entire contents of which is hereby incorporated herein by reference.

### FIELD

Example embodiments of the invention generally relate to a flat image detector.

### BACKGROUND

By way of example, image intensifier camera systems based on television or CCD cameras, storage film systems with an integrated or external readout unit, systems with optical coupling or a converter film to CCD cameras or CMOS chips, selenium-based detectors with electrostatic readout and flat image detectors having active readout matrices with direct or indirect conversion of the X-radiation are known in digital X-ray imaging.

In particular, flat image detectors have been applied for digital X-ray imaging for a few years. An example of such a detector is based on an active readout matrix, for example, made from amorphous silicon (a-Si), pre-coated with an X-ray converter layer or scintillator layer, for example, made from cesium iodide (CsI). The X-radiation occurring is firstly converted into visible light in the scintillator layer. The active matrix is subdivided into a multiplicity of pixel readout units having photodiodes which, in turn, convert this light into electric charge and store it in a spatially resolved fashion.

An active readout matrix is likewise used in the case of a so-called directly converting flat image detector. Arranged upstream of the readout matrix is, however, a converter layer, for example made from selenium, in which the X-radiation occurring is converted directly into electric charge. This charge is then, in turn, stored in a pixel readout unit of the readout matrix. Reference is also made to M. Spahn et al., “Flachbilddetektoren in der Röntgendiagnostik” [“Flat image detectors in X-ray diagnostics”], Der Radiologe 43 (2003), pp. 340 to 350 for the technical background of a flat image detector.

### SUMMARY

In at least one embodiment of the present invention, a flat image detector is provided which can be produced with low outlay and therefore cost effectively and offers increased possibilities of application.

The flat image detector according to at least one embodiment of the invention can be produced with particular simplicity and therefore cost effectively on the basis of the active matrix made from pixel readout units that is at least partially constructed from an organic conducting material or an organic semiconducting material. Integrated components based on such organic materials, in particular organic semiconductor materials, for example organic thin film transistors (oTFT) can be processed substantially more simply in good quality over a large area and can thereby be fabricated with lower outlay and more cost effectively than, for example, known detector plates made from amorphous silicon, or known silicon components. Thus, for example, in the case of organic semiconductor substrate materials, there is no restriction on size as there is in the case of crystalline silicon substrate wafers. Silicon substrate wafers are cut from silicon crystals that, in turn, can be fabricated only up to a diameter of 12 inches with industrially acceptable outlay.

Components that are based on an organic semiconducting material require only process temperatures in the range of room temperature and not temperatures from at least 300° C. to 400° C. as for silicon components. For this reason, it is also possible to use temperature-sensitive materials such as, for example, plastics when producing the active matrix of the flat image detector according to at least one embodiment of the invention.

In addition, the flat image detector according to at least one embodiment of the invention has the advantage of a high degree of flexibility; thus, it can easily be produced as a flexible flat image detector, for example, one that can be adapted to an examination object, in that the active matrix is embodied on a deformable, for example, flexible substrate in a likewise flexible fashion. Such flat image detectors can be used, for example, in dental medicine or mammography.

The flat image detector according to at least one embodiment of the invention further has a substantially lesser weight than a flat image detector according to the prior art; this is particularly advantageous for mobile, portable flat image detectors.

According to one refinement of at least one embodiment of the invention, the active matrix has photodiodes, and the photodiodes are formed at least partially from an organic conducting material or organic semiconducting material. In this case, the photodiodes advantageously have an absorber layer extending continuously over the active matrix, as a result of which the production is particularly simple and low on outlay.

According to a further refinement of at least one embodiment of the invention, the absorber layer is formed from an organic polymer, in particular P3HT (poly-3-hexylthiophene). Organic polymers such as P3HT are particularly easy to process, and their semiconductor properties can be set in a simple way by doping. In addition, such materials have the advantage of a low weight.

### BRIEF DESCRIPTION OF THE DRAWINGS

Embodiments of the invention and further advantageous refinements in accordance with the features of the subclaims are explained in more detail below in the drawings with the aid of schematics of example embodiments without thereby restricting the invention to these example embodiments. In the drawings:

FIG. 1 shows a detail of a cross section through an organic flat image detector according to an embodiment of the invention, with an active matrix having an organic photodiode;

FIG. 2 shows an X-ray system having an organic flat image detector according to an embodiment of the invention; and

FIG. 3 shows a C-arc X-ray system having an organic flat image detector according to an embodiment of the invention.

### DETAILED DESCRIPTION OF THE EXAMPLE EMBODIMENTS

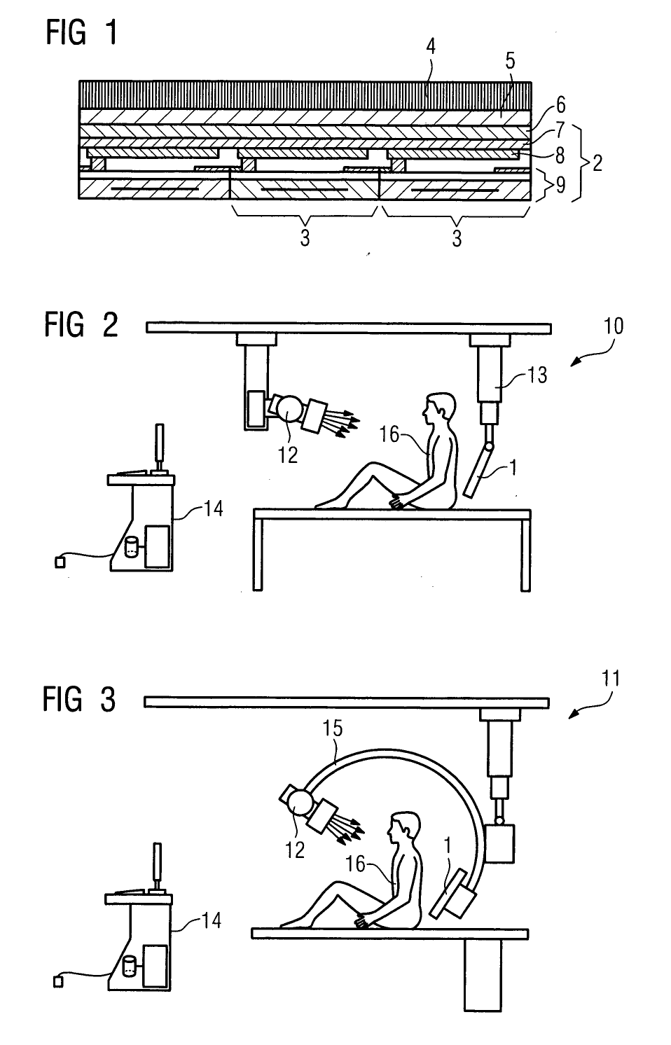

FIG. 1 shows, as a detail of an organic flat image detector according to an embodiment of the invention, an active matrix 2 having an organic photodiode and a scintillator layer 4 applied to the active matrix 2. The scintillator layer 4, for example made from cesium iodide (CsI) or gadolinium oxysulfide (Gd₂O₂S), likewise converts incident X-radiation to light. The light is then converted, in turn, into charge pulses in the active matrix 2 in a spatially resolved fashion by the pixel readout units 3, stored and subsequently passed on to an image processing system with the aid of readout electronics.

A passivation layer 5 is arranged between the active matrix 2 and the scintillator layer 4. Each pixel readout element 3 of the active matrix 2 has a photodiode and a switching element such as, for example, a transistor 9. Each photodiode is designed as a photodiode stack (layer stack) and is formed by a continuous organic absorber layer 7, a first electrode 6 and a second electrode 8. The photodiode is spatially defined for each pixel readout element 3 by the discrete second electrode 8 and the transistor 9. The organic absorber layer 7 can consist, for example, of the organic material poly-3-hexylthiophene (P3HT).

According to a further refinement of an embodiment of the invention, the active matrix 2 has at least one OTFT, an organic thin film transistor. For each pixel readout unit, the respective transistor 9 is, for example, designed as an OTFT and is advantageously based on an organic semiconductor material, for example, on α-ω-dihexylhexathiophene (DH6T).

FIG. 2 shows a medical X-ray system 10 in which an organic flat image detector 1 (oFD) according to an embodiment of the invention is integrated. The organic flat image detector 1 is fastened on a 3D stand 13, and can be appropriately swiveled for projection pictures. The X-ray system 10 has, moreover, a likewise swiveling X-ray source 12 and a control device 14 with an imager system. The organic flat image detector 1 can be, for example, an organic flat image detector 1 that is connected to the control device 14 via a communication link by cable.

FIG. 3 shows a medical C-arc X-ray system 11 in which an organic flat image detector 1 (oFD) according to an embodiment of the invention is integrated. In addition to a control device 14, the C-arc X-ray system 11 comprises a C-arc 15 that has at one end an X-ray source 12, and at its other end an organic flat image detector 1. Such a C-arc X-ray system 11 is suitable, for example, for angiography pictures or cardiology pictures, in particular. Such a C-arc X-ray system 11 can be used to carry out 3D reconstructions of an examination object.

An example embodiment of the invention may be summarized briefly in the following way: in order to configure a flat image detector 1 such that it can be produced with as low an outlay as possible, a flat image detector 1 having an active matrix 2 constructed from pixel readout units 3 is provided, in which at least a part of the active matrix 2 is formed from an organic conducting or semiconducting material.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A flat image detector, comprising:
an active matrix including a plurality of pixel readout units, at least a part of the active matrix being formed from at least one of an organic conducting material and an organic semiconducting material.

2. The flat image detector as claimed in claim 1, wherein the active matrix includes photodiodes, and wherein the photodiodes are formed at least partially from at least one of the organic conducting and semiconducting material.

3. The flat image detector as claimed in claim 2, wherein the photodiodes include an absorber layer extending continuously over the active matrix.

4. The flat image detector as claimed in claim 3, wherein the absorber layer is formed from an organic polymer.

5. The flat image detector as claimed in claim 1, wherein the active matrix includes at least one organic thin film transistor.

6. The flat image detector as claimed in claim 1, wherein the active matrix is arranged on a substrate consisting of an organic material.

7. The flat image detector as claimed in claim 6, wherein the flat image detector is of flexible design.

8. The flat image detector as claimed in claim 1, wherein the flat image detector is designed for use in a medical X-ray machine.

9. The flat image detector as claimed in claim 4, wherein the organic polymer is P3HT (poly-3-hexylthiophene).

10. The flat image detector as claimed in claim 6, wherein the substrate is a flexible substrate.

11. A medical X-ray machine comprising the flat image detector as claimed in claim 1.

12. A X-ray system comprising the flat image detector as claimed in claim 1.

13. The X-ray system of claim 12, wherein the active matrix of the flat image detector includes photodiodes, and wherein the photodiodes are formed at least partially from at least one of the organic conducting and semiconducting material.

14. The X-ray system of claim 12, comprising an integrated flat image detector as claimed in claim 1.

15. The X-ray system of claim 12, further comprising:
a swiveling X-ray source; and
a control device with an imager system.

16. The X-ray system of claim 15, wherein the flat image detector is connected to the control device via a communication link.
